(19) United States
(12) Patent Application Publication
(10) Pub. No.: US 2011/0089727 A1
(43) Pub. Date: Apr. 21, 2011

(54) PRETENSIONER FOR VEHICLE SEAT

(75) Inventor: Eiji Masutani, Tochigi-ken (JP)

(73) Assignee: TS TECH CO., LTD., Asaka-shi, Saitama-ken (JP)

(21) Appl. No.: 12/681,389

(22) PCT Filed: Oct. 2, 2008
(86) PCT No.: PCT/JP2008/067969

§ 371 Date: Dec. 21, 2010

(30) Foreign Application Priority Data
Oct. 2, 2007 (JP) 2007-258331

(51) Int. Cl. B60N 2/42; B60R 21/02; B60R 22/46

(52) U.S. Cl. 297/216.1

(57) ABSTRACT

The present pretensioner includes a cylinder (43), a piston (44) that moves inside the cylinder, and a gas generator (45) that moves the piston by supplying a gas into an expansion chamber (49) inside the cylinder. The gas generator is arranged inside the piston. A first cable (40A) to move a movable member M of a vehicle seat is coupled to the piston and a second cable (40B) to move the movable member is coupled to the cylinder.

### TECHNICAL FIELD

The present invention relates to a vehicle seat, and in particular to a pretensioner that protects a seat occupant by moving a movable member such as a seat bottom or a seat belt when a large external force acts on a vehicle body due to a vehicle collision or the like.

### BACKGROUND ART

A pretensioner that suppresses unfavorable forward movement of a seat occupant by tightening a seat belt when a large external force acts on a vehicle body due to a vehicle collision or the like has been known. Also, a pretensioner that moves a vehicle seat when a vehicle collision occurs has been proposed.

A conventional pretensioner includes a cylinder, a piston that moves inside the cylinder, and a gas generator that moves the piston by supplying a gas into an expansion chamber inside the cylinder.
Patent Document 1: JP 2003-146184A1

### DISCLOSURE OF THE INVENTION

A conventional gas generator is arranged outside a cylinder. To connect such an exposed gas generator to an expansion chamber inside the cylinder, there have been various restrictions. Moreover, if the gas generator is arranged outside the cylinder, the cylinder is provided with a large projected portion, which imposes restrictions on the mounting position of the cylinder. A cylinder having a distorted appearance is more likely to come into contact with other members of a vehicle or the body of a seat occupant. Such a contact may shift the cylinder from the correct mounting position.

An object of the present invention is to provide a pretensioner that solves the above issues. For that purpose, according to the present invention, a gas generator is arranged inside a piston.

### BRIEF DESCRIPTION OF THE DRAWINGS

FIG. 1 is a sectional view of a pretensioner according to a first embodiment of the present invention.

FIG. 2 is an exploded perspective view of the pretensioner.

FIG. 3 is a sectional view of a pretensioner according to a second embodiment of the present invention.

FIG. 4 is a comparison diagram of a pre-activation state and a post-activation state of the pretensioner.

FIG. 5 is a perspective view of a vehicle seat in which the pretensioner is used.

FIG. 6 is a perspective view showing a seat bottom frame and a slide mechanism of the vehicle seat.

FIG. 7 is a perspective view of the seat bottom frame from another angle.

FIG. 8 is a side view of the seat bottom before the pretensioner is activated.

FIG. 9 is a side view of the seat bottom after the pretensioner is activated.

FIG. 10 is a perspective view showing the vehicle seat provided with the pretensioner for a seat belt.

FIG. 11 is a perspective view showing a cable guide of the vehicle seat and a wire cable of the seat belt pretensioner.

### BEST MODE FOR CARRYING OUT THE INVENTION

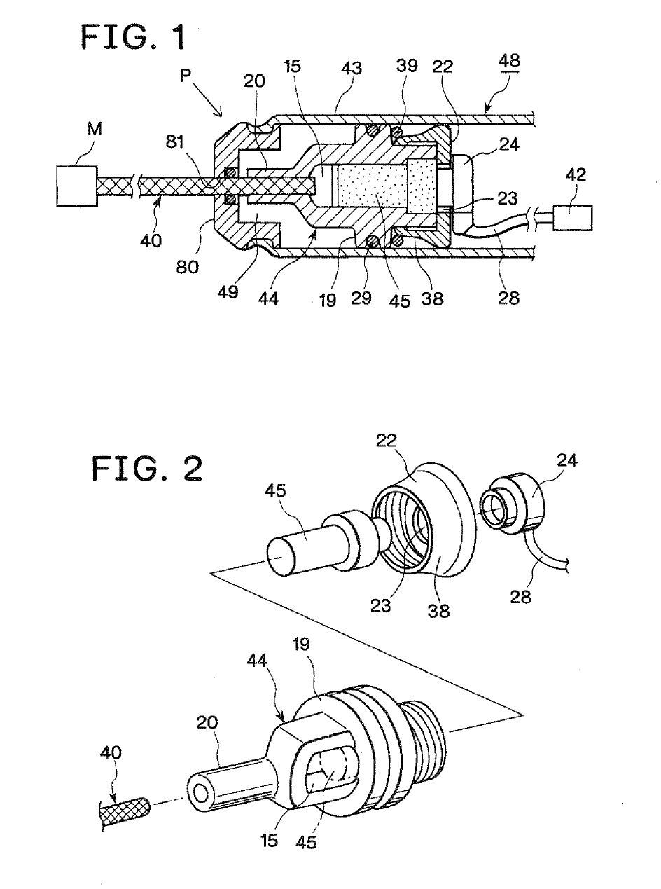

FIGS. 1 and 2 show an actuator or a pretensioner P according to a first embodiment of the present invention. The pretensioner P moves a movable member M of a vehicle seat 1, for example, a seat bottom 3 or a seat belt 10. The pretensioner P suitably moves the movable member M when an unfavorable strong inertial force arises due to, for example, a traffic accident, to thereby reduce damage to the seat occupant.

The pretensioner P includes a cable towing unit 48 composed of a cylinder 43 and a piston 44 that moves inside the cylinder 43. A seal member 80 is mounted on one end of the cylinder 43. One end of a wire cable 40 is coupled to the piston 44 and the other end of the wire cable 40 extends to an outer side via a passage 81 through the center of the seal member 80 to be coupled to the movable member M.

An expansion chamber 49 surrounded by the cylinder 43 is sectioned between the piston 44 and the seal member 80. A micro gas generator 45 in a cylindrical shape to supply a large quantity of gas to the expansion chamber 49 is accommodated inside the piston 44. The gas generator 45 and the expansion chamber 49 are in communication with each other via a gas nozzle 15. If a large quantity of gas is supplied from the gas generator 45 to the expansion chamber 49, the piston 44 moves to the right in FIG. 1 to move the movable member M via the wire cable 40.

The piston 44 includes a cylindrical portion 19 in contact with an inner circumferential surface of the cylinder 43 and a cable holder 20 to which the wire cable 40 is coupled. The gas generator 45 is firmly attached to the piston 44 by a holding cap 22 mounted on an edge of the piston 44. The holding cap 22 is suitably screwed into the piston 44.

A coupler 24 electrically connected to a collision detector 42 via a harness 28 is mounted on an edge of the gas generator 45. The coupler 24 is arranged in a window 23 formed in the center section of the holding cap 22. The collision detector 42 is provided in a desired position of a body 6 (FIG. 10) to detect an unfavorable strong inertial force caused by a traffic accident or the like. Output of the collision detector 42 is transmitted to the gas generator 45 via the coupler 24 and the gas generator 45 supplies thereby a large quantity of gas to the expansion chamber 49.

When the movable member M, for example, the seat belt 10 moves due to activation of the gas generator 45, the seat occupant is appropriately supported by the seat belt 10 in an extremely short time, reducing damage to the seat occupant significantly.

In the pretensioner P according to the first embodiment, the gas generator 45 is arranged inside the cylinder 43 and suitably inside the piston 44. Thus, the outside shape of the cylinder 43 can be formed smoothly without any projection. The cylinder 43 (cable towing unit 48) substantially without projection can easily be mounted and arranged in a smaller space.

As is evident from FIG. 1, an O ring 29 is provided in the cylindrical portion 19. The outer circumference of the holding cap 22 is formed as an inclined plane 38 and a stopper steel ball 39 is provided between the inclined plane 38 and the cylinder 43.

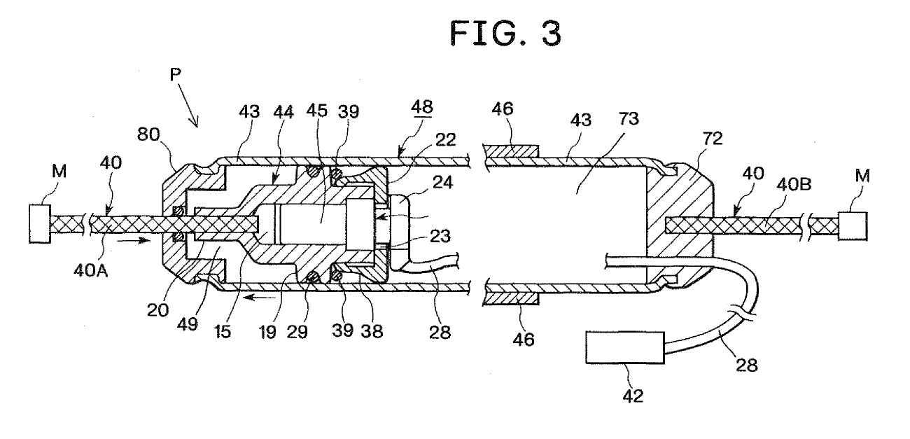

FIG. 3 shows another embodiment of the pretensioner P. While the pretensioner P in FIG. 1 is provided with substantially a single output, the pretensioner P in FIG. 3 is provided with double outputs. The double-output pretensioner P is appropriate to move two movable members M. The pretensioner P is also appropriate to smoothly move one movable member M by towing two locations of one movable member M, for example, a right-side portion and a left-side portion thereof.

The pretensioner P in FIG. 3 is equipped with double outputs and thus includes a first cable 40A and a second cable 40B. The first cable 40A couples, like the single-output pretensioner P, the piston 44 and the left-side movable member M. The second cable 40B couples the cylinder 43 and the right-side movable member M.

In the embodiment in FIG. 3, the second cable 40B is coupled to a coupling cap 72 fixed to the cylinder 43. A space 73 between the coupling cap 72 and the piston 44 is a non-sealed space in communication with the outside and the air inside the space 73 is not compressed even if the piston 44 in the state in FIG. 3 moves to the right.

The cylinder 43 is movably mounted on the vehicle body 6 or the vehicle seat 1 in the length direction of the cylinder 43 by a guide member 46.

When the gas generator 45 supplies a large quantity of gas to the expansion chamber 49 due to a vehicle collision, the piston 44 is pushed to the right with respect to the cylinder 43 in FIG. 3. What is important is that the cylinder 43 according to the present invention is movable in the length direction with respect to the guide member 46. Thus, a large quantity of gas supplied into the expansion chamber 49 pushes the piston 44 to the right with respect to the cylinder 43 and at the same time, moves the cylinder 43 to the left with respect to the piston 44. In other words, the piston 44 and the cylinder 43 move in opposite directions by mutual reaction forces.

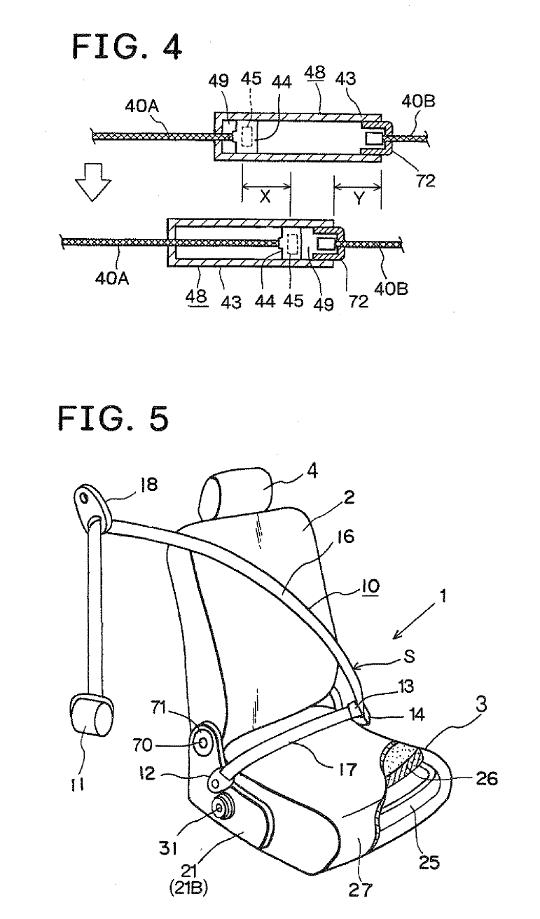

FIG. 4 shows states that allow the piston 44 and the cylinder 43 to move and when a large quantity of gas is supplied into the expansion chamber 49, the piston 44 and the cylinder 43 change from the state shown above before the vehicle collision to the state shown below after the vehicle collision. In the state after the vehicle collision, the piston 44 moves to the right by a distance X to move the left-side movable member M via the first cable 40A. The cylinder 43 moves to the left by a distance Y to move the right-side movable member M via the second cable 40B.

In order for the piston 44 and the cylinder 43 to move the same distance by mutual reaction forces, the piston 44 and the cylinder 43 desirably have the same weight. This condition can more easily be met by providing the gas generator 45 inside the piston 44 to increase the weight of the piston 44.

Thus, according to the present invention, gas energy can be divided and transmitted to two movable members (or two locations of one movable member) substantially simultaneously so that the movable members can smoothly be moved.

According to the present invention, the piston 44 and the cylinder 43 move due to mutual reaction forces and thus, the moving distance X of the piston 44 and the moving distance Y of the cylinder 43 become substantially equal. This is appropriate to move the movable member smoothly.

According to the present invention, the piston 44 and the cylinder 43 move in opposite directions and thus, it becomes easier to secure a movement space for the piston 44 and the cylinder 43. That is, the piston 44 in the present application moves inside the space 73 of the cylinder 43, instead of projecting to the outer side from the cylinder 43.

According to the present invention, the movable member M can be moved by one gas generator 45 and one cable towing unit 48 and thus, the pretensioner can be manufactured at low costs.

Next, a concrete example of moving the seat bottom 3 of the vehicle seat 1 by the pretensioner P will be described.

As shown in FIG. 5, the vehicle seat 1 includes the backward movable seat bottom 3, a seatback 2, and a headrest 4. The seat bottom 3 is suitably mounted on the vehicle body (floor panel) 6 slidably via a slide mechanism 5.

The slide mechanism 5 includes lower rails 7, 7 fixed to the vehicle body 6 and upper rails 8, 8 slidably engaged with the lower rails 7, 7. Each upper rail 8 is provided with a raised bracket 21 and the seatback 2 is rotatably supported by a pivot 70 in the raised bracket 21. The seatback 2 is held at any angle by a reclining mechanism 71.

The vehicle seat 1 includes a seat belt mechanism S. The seat belt mechanism S includes the seat belt 10, a belt retractor 11 coupled to the base of the seat belt 10, a tongue plate 13 attached to a midpoint of the seat belt 10, a tongue anchor 14 with which the tongue plate 13 is removably engaged, and a tip anchor 12 coupled to the tip of the seat belt 10. The belt retractor 11 protects a seat occupant by regulating withdrawal of the seat belt 10 to bind the seat occupant when a strong inertial force acts on the seat occupant due to a collision in a traffic accident or the like (hereinafter, a vehicle collision). The tongue plate 13 is attached to the seat belt 10 in such a way that the position thereof can freely be adjusted.

The seat belt 10 is divided into a shoulder belt 16 between the belt retractor 11 and the tongue plate 13 and a lap belt 17 between the tongue plate 13 and the tip anchor 12. The seat belt mechanism S further includes a through anchor 18 that supports the shoulder belt 16. The through anchor 18 and the belt retractor 11 are generally arranged on the side of the vehicle body 6, but may be provided on the side of the seatback 2.

The seat bottom 3 includes a seat bottom frame 25 in a rectangular frame, a cushion 26 such as urethane mounted on the frame 25, and a skin 27.

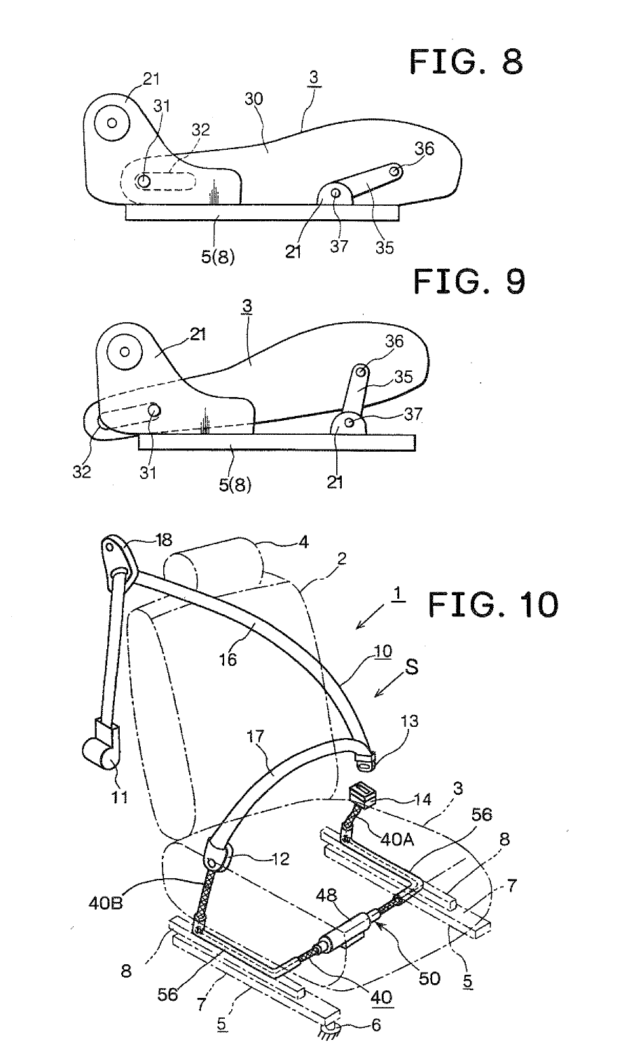

In the embodiment shown in FIGS. 5 to 9, each side panel 30 of the bottom frame 25 includes a substantially horizontal support slot 32 extending in a back-and-forth direction of the seat and each bracket 21 includes a slide pin 31 inserted into the support slot 32. A front portion of the seat bottom 3 is supported by the bracket 21 through a link mechanism. The link mechanism includes an arm 35, one end of the arm 35 is rotatably coupled to a front portion of the side panel 30 of the seat bottom 3 by a shaft 36 and the other end of the arm 35 is rotatably coupled to the raised bracket 21 by a shaft 37. The arm 35 is inclined, as shown in FIG. 8, about 30 degrees in a normal state. If an external force toward the rear acts on the seat bottom 3, as shown in FIG. 9, the front side of the seat bottom 3 moves backward while moving upward and the rear side of the seat bottom 3 moves backward along the slot 32.

If the vehicle seat 1 is not provided with the slide mechanism 5, the raised brackets 21, 21 are fixed to the vehicle body 6.

The vehicle seat 1 includes a first pretensioner 41 that reduces forward movement of a seat occupant when a vehicle collision occurs. The pretensioner P shown in FIG. 3 is used as the pretensioner 41. The cable towing unit 48 of the pretensioner 41 is suitably mounted on the seat bottom 3.

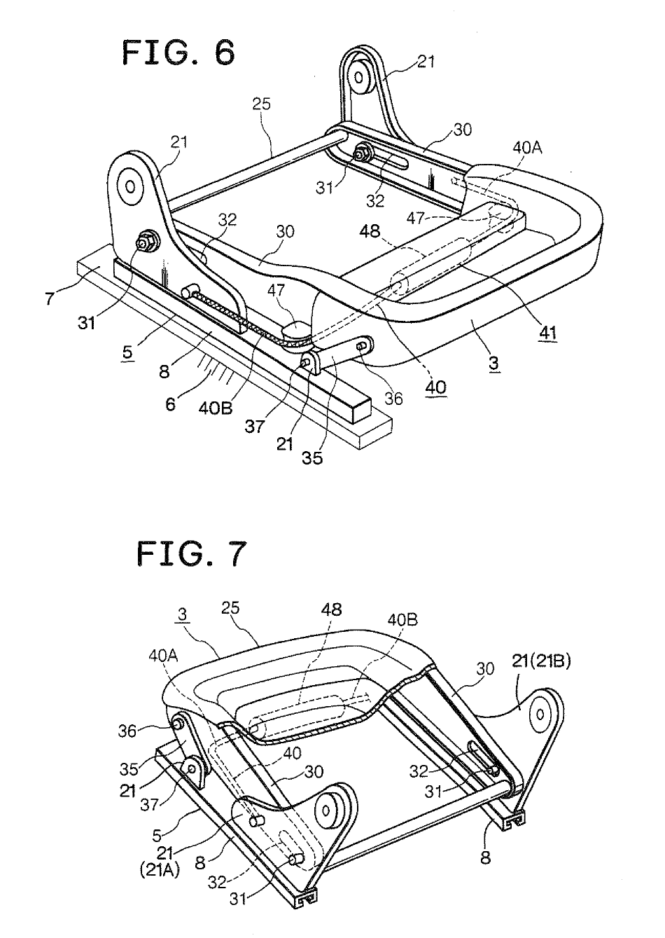

The cylinder 43 extends, as shown in FIGS. 6 and 7, in the width direction of the seat 1 and is arranged below the front portion of the seat bottom 3. An accommodation space can easily be secured below the front portion of the seat bottom 3 without losing comfort of the seat bottom 3. Since the cylinder 43 extends in the width direction of the seat, a wide free space can be secured below a rear portion of the seat bottom 3. The free space provides comfort to a seat occupant in a rear seat by accepting feet of the seat occupant in the rear seat. The cylinder extending in the back-and-forth direction makes the space below the rear portion of the seat bottom 3 narrower.

The wire cable 40 includes the first cable 40A coupled to a first bracket 21A of the raised bracket 21 and the second cable 40B coupled to a second bracket 21B of the raised bracket 21. The other end of the first cable 40A is coupled to the piston 44, and the other end of the second cable 40B is coupled to the coupling cap 72 fixed to the cylinder 43.

The cables 40A and 40B each extend to the outer side along a shaft center direction of the cylinder 43 (width direction of the seat) from the cable towing unit 48 to be led to the rear by rollers 47, 47 provided in the side panels 30, before being coupled to the raised brackets 21A and 21B.

If the gas generator 45 supplies a large quantity of gas into the expansion chamber 49 due to a vehicle collision, the piston 44 and the cylinder 43 of the cable towing unit 48 move in mutually opposite directions to pull the raised brackets 21A and 21B. Thus, the seat bottom 3 on which the cable towing unit 48 is mounted moves relatively backward with respect to the vehicle body 6 (brackets 21A and 21B). The backward movement of the seat bottom 3 reduces the unfavorable forward movement of the seat occupant when a vehicle collision occurs. Since the gas generator 45 is arranged inside the cylinder 43, the gas generator 45 will not interfere with other members when the cylinder 43 moves.

According to the present invention, gas energy can be divided and transmitted to the first bracket 21A and the second bracket 21B substantially simultaneously so that the seat bottom 3 can smoothly be moved backward.

According to the present invention, the piston 44 and the cylinder 43 move due to mutual reaction forces and thus, the moving distance X of the piston 44 and the moving distance Y of the cylinder 43 become substantially equal. Thus, the seat bottom 3 can smoothly be moved.

According to the present invention, the piston 44 and the cylinder 43 move in opposite directions and thus, it becomes easier to secure a movement space for the piston 44 and the cylinder 43. That is, the piston 44 in the present application moves inside the space 73 of the cylinder 43, instead of projecting to the outer side from the cylinder 43.

According to the present invention, the seat bottom 3 can be moved by one gas generator 45 and one cable towing unit 48 and thus, the pretensioner can be manufactured at low costs.

According to the present invention, each edge of the first cable 40A and the second cable 40B extends in the length direction of the cylinder 43 and thus, the first cable 40A and the second cable 40B can efficiently be coupled to the piston 44 and the cylinder 43.

The cable towing unit 48 can also be mounted on the vehicle body 6, in which case the wire cables 40, 40 are coupled to the side panels 30, 30, instead of the raised brackets 21, 21.

Next, a concrete example of pretensioning the seat belt mechanism S of the vehicle seat 1 by the pretensioner P will be described.

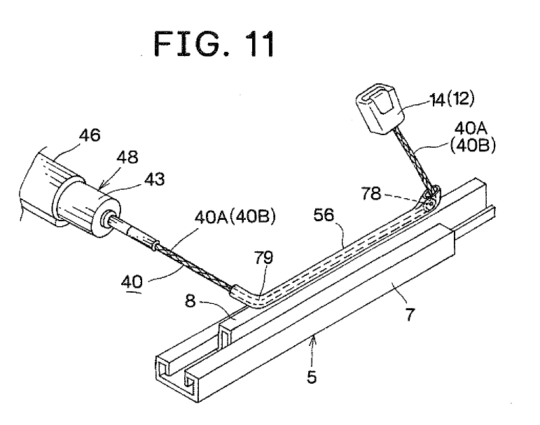

The vehicle seat 1 shown in FIGS. 10 and 11 includes a second pretensioner 50 that reduces forward movement of a seat occupant by actively tightening the seat belt 10 when a vehicle collision occurs. The pretensioner P shown in FIG. 3 is used as the pretensioner 50.

The second pretensioner 50 includes the first cable 40A coupled to the tongue anchor 14 and the second cable 40B coupled to the tip anchor 12.

When the collision detector 42 detects a vehicle collision, the gas generator 45 instantaneously supplies a large quantity of gas to the cable towing unit 48 and the cable towing unit 48 moves the tongue anchor 14 and tip anchor 12 via the wire cable 40 by dint of expansion energy of the gas, thereby actively tightening the seat belt 10. The seat occupant is bound by the seat belt 10 from early on so that unfavorable forward movement of the seat occupant is reduced.

What is important here is that the pretensioner 50 moves both the tongue anchor 14 and tip anchor 12. Moving both can tighten, when compared with movement of one of both, the seat belt 10 earlier and stronger.

It is also important to note that the pretensioner 50 moves both the tongue anchor 14 and tip anchor 12 substantially simultaneously. Compared with non-simultaneous movement or movement of one of both, simultaneous movement can bind the seat occupant in a stable posture. “Substantially simultaneously” means that no conscious time difference is provided.

As shown in FIG. 11, each upper rail 8 of the slide mechanism 5 is provided with a hollow cable guide 56 through which an intermediate portion of the cables 40A and 40B passes. The cable guide 56 extends in the back-and-forth direction and a roller or pulley 78 to guide the cables 40A and 40B upward is provided at the rear end of the cable guide 56. Further, an inward curving unit 79 to guide the cables 40A and 40B toward the cable towing unit 48 is provided at the front end of the cable guide 56.

The cylinder 43 is mounted on the vehicle body 6 movably in the length direction of the cylinder 43 by the guide member 46. Both sides of the cylinder 43 are supported substantially by the cables 40A and 40B and thus, the guide member 46 may be omitted.

The second pretensioner 50 is substantially the same as the first pretensioner 41 and thus has operations and effects equivalent to those of the first pretensioner 41.

According to the present invention, the tongue anchor 14 and the tip anchor 12 can be moved by gas energy and thus, the seat belt 10 can be moved significantly.

According to the present invention, the tongue anchor 14 and the tip anchor 12 can be moved by gas energy and thus, the seat belt 10 can be moved early.

According to the present invention, the tongue anchor 14 and the tip anchor 12 can be moved substantially simultaneously by gas energy and thus, a seat occupant can be protected by binding the seat occupant in a stable posture.

According to the present invention, the piston 44 and the cylinder 43 move due to mutual reaction forces and thus, the moving distance X of the piston 44 and the moving distance Y of the cylinder 43 become substantially equal. Therefore, a seat occupant can be protected by binding the seat occupant in a stable posture. “Substantially equal” means that the moving distance is consciously made to make no difference.

According to the present invention, the piston 44 and the cylinder 43 move in opposite directions and thus, it becomes easier to secure a movement space for the piston 44 and the cylinder 43.

According to the present invention, the tongue anchor 14 and the tip anchor 12 can be moved by one cable towing unit 48 and thus, the pretensioner can be manufactured at low costs.

According to the present invention, the tongue anchor 14 and the tip anchor 12 can be moved by the cable towing unit 48 and thus, the pretensioner can be manufactured at low costs.

According to the present invention, each edge of the first cable 40A and the second cable 40B extends in the length direction of the cylinder 43 and thus, the first cable 40A and the second cable 40B can efficiently be coupled to the piston 44 and the cylinder 43.

According to the present invention, forward movement of a seat occupant can effectively be reduced by including the first pretensioner 41 and the second pretensioner 50. Moreover, the seat bottom 3 and the seat belt 10 are moved by the separate mechanisms 41 and 50 and thus, the amount of movement and the moving speed can easily be set and changed.

1. A vehicle seat pretensioner for moving a movable member of a vehicle seat when a vehicle collision occurs, comprising:
a cylinder;
a piston that moves inside the cylinder; and
a gas generator that moves the piston by supplying a gas into an expansion chamber inside the cylinder,
wherein the gas generator is arranged inside the cylinder.

2. The vehicle seat pretensioner according to claim 1, wherein the gas generator is arranged inside the piston.

3. The vehicle seat pretensioner according to claim 2, wherein the piston includes a gas nozzle that makes the expansion chamber communicate with the gas generator.

4. The vehicle seat pretensioner according to claim 3, wherein a coupler electrically connected to a collision detector via a harness is connected to the gas generator.

5. The vehicle seat pretensioner according to claim 2, wherein a holding cap to prevent the gas generator from being detached from the piston is provided in a rear portion of the piston.

6. The vehicle seat pretensioner according to claim 5, wherein the holding cap is screwed into the piston.

7. The vehicle seat pretensioner according to claim 5, wherein a cable holder that fixes a wire cable to move the movable member is provided on a front side of the piston.

8. The vehicle seat pretensioner according to claim 2, wherein the piston comprises:
a cylindrical portion in contact with an inner circumferential surface of the cylinder;
a cable holder that fixes a wire cable to move the movable member; and
a gas nozzle that is provided between the cylindrical portion and the cable holder and makes the expansion chamber communicate with the gas generator.

9. The vehicle seat pretensioner according to claim 2, wherein a first wire cable to move the movable member is coupled to the piston and a second wire cable to move the movable member is coupled to the cylinder.

10. The vehicle seat pretensioner according to claim 2, wherein a first wire cable to move the movable member is coupled to the piston and a second wire cable to move a different movable member from the movable member is coupled to the cylinder.
